(19) United States
(12) Patent Application Publication
(10) Pub. No.: US 2008/0247531 A1
(43) Pub. Date: Oct. 9, 2008

(54) Techniques for Populating a Contact List

(76) Inventors: Daniel M. Borislow, Palm Beach, FL (US); Gregory L. Wood, Oneonta, AL (US)

Correspondence Address: ARNOLD & PORTER LLP;ATTN: IP DOCKETING DEPT., 555 TWELFTH STREET, N.W., WASHINGTON, DC, 20004-1206, US

(21) Appl. No.: 12/061,466

(22) Filed: Apr. 2, 2008

Related U.S. Application Data
(60) Provisional application No. 60/909,896, filed on Apr. 3, 2007.

(51) Int. Cl. H04M 3/487

(52) U.S. Cl. 379/218.01

(57) ABSTRACT

The invention relates to a system, device, computer readable medium, and process for populating a contact list using a client device with service provider contact information based on location information.

### CROSS-REFERENCE TO RELATED APPLICATIONS

This application claims the benefit under 35 U.S.C. § 120 of U.S. Provisional Application No. 60/909,896, filed Apr. 3, 2007, the entirety of which is incorporated herein by reference.

### BACKGROUND OF THE INVENTION

1. Field of the Invention

The invention relates to a system, device, computer readable medium, and process for populating a contact list using a client device with service provider contact information based on location information.

2. Related Art

Currently there are a variety of alternatives to the traditional public switched telephone network (PSTN). For example, current telephone systems may use a packet switched network, which is typical in a computer data environment, rather than a circuit switched network, for a telephone connection. Rather than sending voice information through the traditional circuit-committed protocols of the PSTN, packet switched networks may rely on Voice over Internet Protocol (VoIP) implementations, which facilitate the delivery of voice information using the Internet Protocol (IP), whereby voice information is packaged in a digital form in discrete packets.

Alternatively, cellular networks enable wireless access to a telephone network by allowing a cellular phone to connect to a nearby cellular base station through an air interface. In addition to voice communications, cellular networks also allow data communications. For example, cellular phones can send and receive messages through a Short Message Service (SMS) and can retrieve and display web pages through wireless cellular links.

A Digital Enhanced Cordless Telecommunications (DECT) system is designed for short-range use as a way of implementing residential and business cordless phone communications. DECT terminals can work with DECT systems which are connected to the GSM infrastructure and all roaming scenarios based on SIM roaming are applicable.

These are just some examples of the alternatives now available to traditional telephones. More than ever, people are traveling for both work and leisure, are spending increasing amount of time on a computer, again both for work and leisure, and families and friends are often far away, making telephone calls an important means to stay in touch. These needs have encouraged the advent of new telecommunication technologies that are portable, convenient, and cost efficient and have led to the development of many alternatives to the traditional land line.

This increase in options, along with more competition among traditional telephone companies, have lowered the cost of telephone calls over the past several years. Consumers of all ages along with businesses throughout the world rely on the telephone as an everyday part of life. Keeping the costs low is important to consumers, as is apparent from the numerous promotions and fierce competition among cellular providers, long distance providers, and VoIP providers.

Most providers of telephone service of any kind charge a monthly flat fee for the service, plus additional fees for such things as long distance calls, excess minutes, calling outside of a network, calling outside of certain time frames, and calling internationally. Consumers must worry about talking too long, or calling at the wrong time or to the wrong place. In addition, the monthly fee can be quite high.

Thus there is a need for a telephone service that can provide low cost or free calls to consumers while generating revenue from a source other than the customers.

### SUMMARY OF THE INVENTION

This invention is related to a system, device, computer readable medium, and process for populating a contact list using a client device. In accordance with one embodiment of the present invention, a client device, which may be a USB device, may be coupled to a first processor based device. In accordance with an exemplary process of the present invention, a unique client identifier is received from the client device and a first search of a client database is conducted to determine if the unique client identifier is present in the client database. The exemplary process also includes retrieving from the client database location identifying information associated with the unique client identifier, if a determination is made that the unique client identifier is present in the client database. The exemplary process also includes searching a service provider database to identify service provider phone numbers that correspond to the location identifying information associated with the unique client identifier and retrieving at least one of the service provider phone numbers that correspond to the location identifying information from the service provider database. The exemplary process includes sending the service provider phone numbers to the client device, such that the client device populates the contact list using the service provider phone numbers.

### BRIEF DESCRIPTION OF THE DRAWINGS

FIG. 1 illustrates an exemplary embodiment of a computer system in which the invention may be employed.

FIG. 2 illustrates a high-level component diagram of a client device in accordance with one embodiment of the present invention.

FIG. 3 illustrates an example of a softphone user interface, including a service provider segment, a phone segment, and a contact list segment, in accordance with one embodiment of the present invention.

FIG. 4 depicts a network environment in which a client device of the present invention may be employed.

FIG. 5a illustrates an example of a table from an exemplary client database that may be employed in conjunction with an embodiment of the present invention. FIG. 5b illustrates one row from the table.

FIG. 6a illustrates an example of a table from an exemplary service provider database that may be employed in conjunction with an embodiment of the present invention. FIG. 6b illustrates one row from the table.

FIGS. 7a and 7b illustrate, in accordance with the present invention, exemplary processes for populating a contact list using a client device from the perspective of a server.

FIG. 8 illustrates, in accordance with the present invention, an exemplary process for populating a contact list using a client device from the perspective of a client device.

### DETAILED DESCRIPTION OF EMBODIMENTS OF THE INVENTION

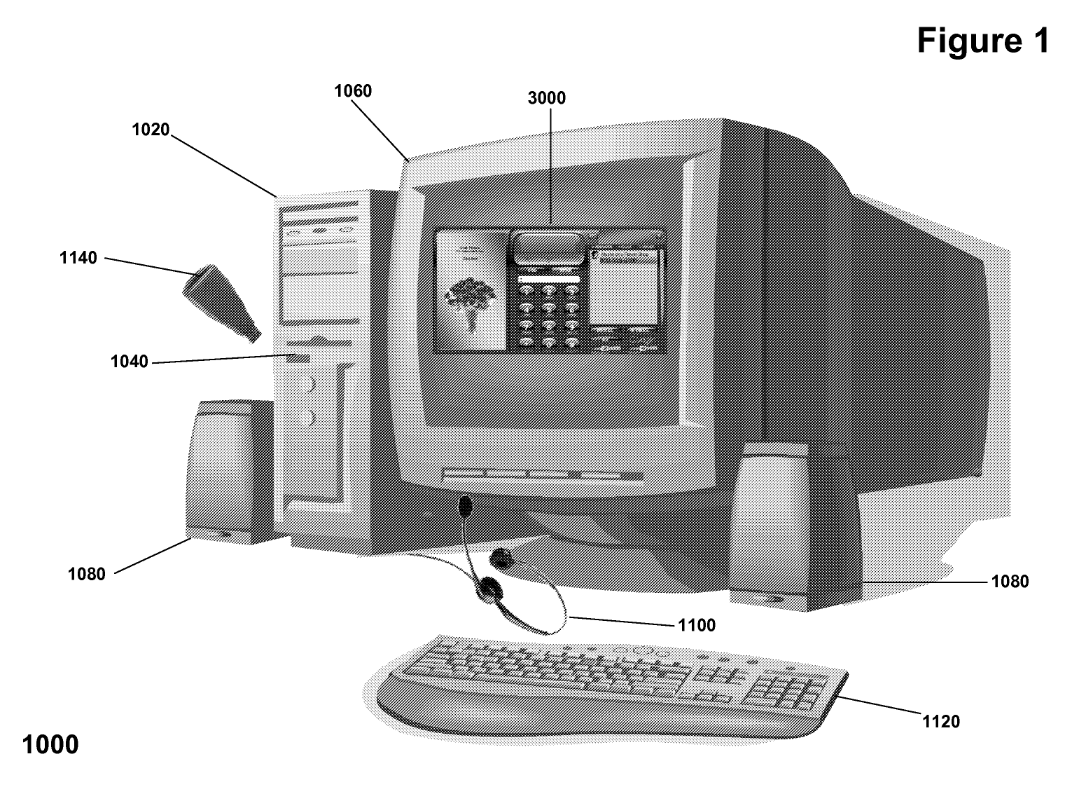

FIG. 1 illustrates an exemplary embodiment of a system 1000 in which the invention may be employed. In particular, the system 1000 includes a computer 1020 having a number of components, including at least a processor, input/output capability, and memory. The memory may include, by way of example, random access memory, read only memory, flash memory, a hard drive, and optical disc drives. The computer 1020 may also support the use of other memory devices by providing input/output ports 1040 for USB devices, Ethernet based devices, flash memory devices, as well as other types of devices, such as video devices (e.g., monitors 1060 and televisions), speakers 1080, and headsets 1100 for communicating with others via one or more voice communications channels. The computer 1020 may also have wireless input/output capability (e.g., Bluetooth and RF) that will support communication with other devices, such as a wireless PDA, a wireless keyboard 1120, a wireless headset, or a wireless mouse.

The system 1000 also supports the use of a client device 1140 that implements telephone functionality (i.e. softphone functionality) in accordance with the present invention. The client device 1140 can be used to implement telephony service via at least a packet switched network. Preferably, the telephony service is a VoIP service.

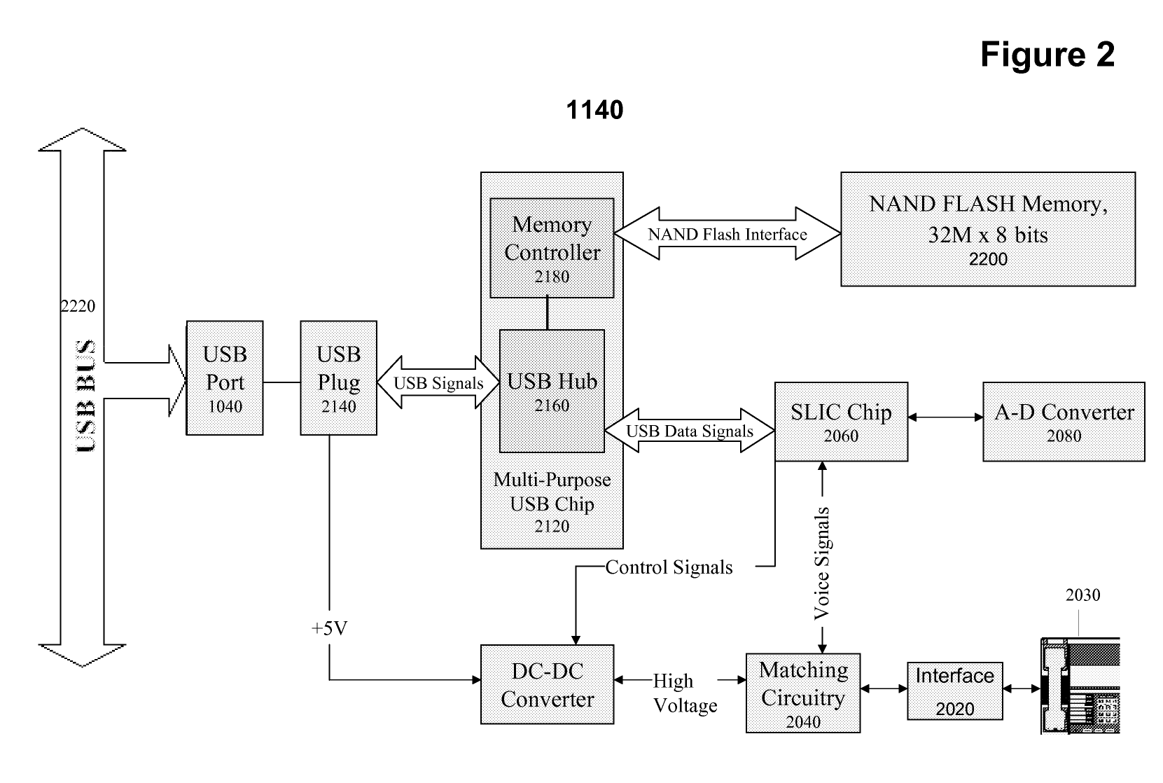

FIG. 2 shows one example of a client device. The client device 1140 includes a first communication interface 2020, which may be a plain old telephone service (POTS) interface including an RJ-11 jack, that is coupled to and receives signals from an analog telephone 2030 or hand set. However, another type of communication interface could be employed that is coupled to and receives digital signals from a digital telephone or handset, or a base station or router that receives signals from and transmits signals to a digital telephone or hand set. The first communication interface 2020 is coupled via matching circuitry (including a transformer) 2040 to a subscriber line interface (SLIC) chip 2060, which performs basic telephony functions, such as generating a ring current, and detecting on-hook and off-hook transitions. The SLIC chip 2060 is coupled to an analog-to-digital converter 2080 that converts analog signals to digital signals on behalf of the SLIC chip 2060. The SLIC chip 2060 is coupled to a multipurpose USB chip 2120 that enables connectivity to other devices that support communication via a USB interface, which may be a USB plug 2140. By way of example, the client device 1140 may communicate with one device via an audio and/or video format that is supported by Windows®. The multipurpose USB chip 2120 incorporates a USB hub 2160 and a memory controller 2180 that is coupled to the USB hub 2160. The memory controller 2180 regulates access to a memory 2200, which may be a Flash Memory (e.g., NAND, RAM, ROM, or a combination thereof). The memory controller 2180 controls access to the memory 2200 to perform read/write operations. The USB Hub 2160 and the memory controller 2180 of the multipurpose USB chip 2120 are both coupled to each other and a connector, such as a USB plug connector 2140 that interfaces with the USB port 1040 and ultimately the USB bus 2220 of the computer. The memory 2200 of the client device 1140 stores software that implements a softphone.

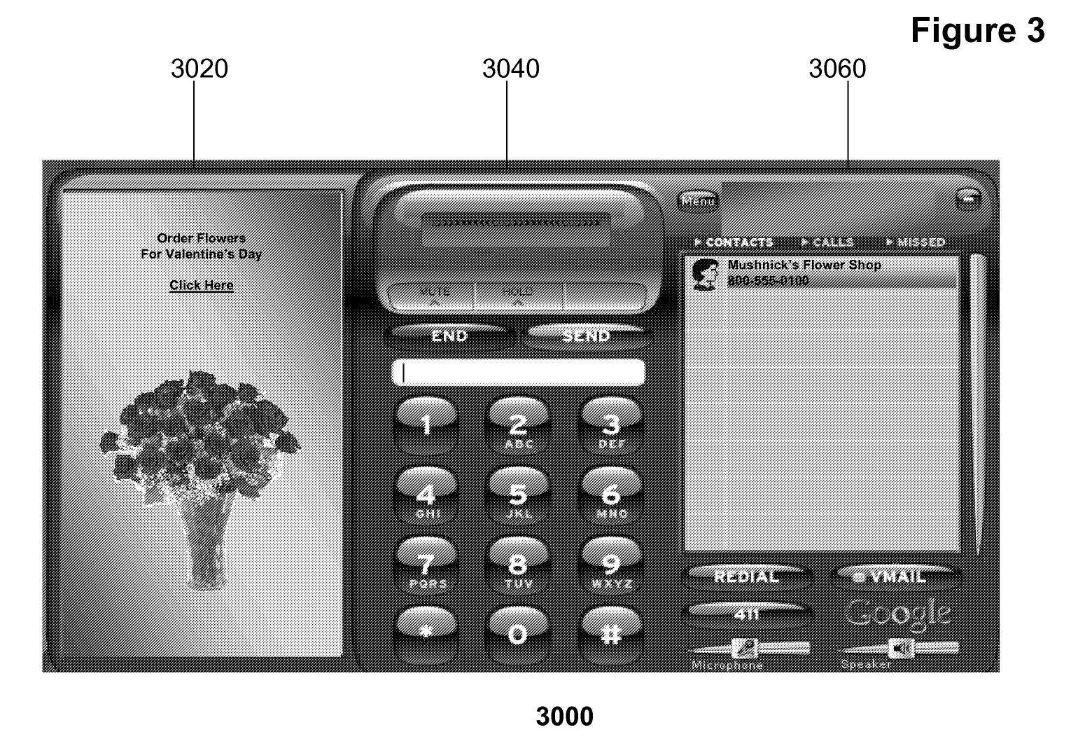

Upon insertion of the client device 1140 into a USB port 1040 of the computer 1020, the microprocessor of the computer 1020 will begin to execute the software instructions of the softphone. Thereafter, a softphone user interface 3000, as shown in FIG. 3, is presented on the monitor 1060 for a user's review. The softphone user interface 1160, includes a service provider segment 3020, a phone segment 3040, and a contact list segment 3060. The customer can use the softphone by talking into a microphone (not shown) or the headset 1100 coupled to the computer 1020 and listening through speakers 1080 or a head set 1100 that are attached to a sound card in the computer. Alternatively, the user may couple to the computer 1020 via the client device 1140 to at least one of a POT 2030, a USB telephone, a cellular telephone, a cordless telephone, DECT phone, or any other type of telephone-like device 2030 enabling the user to communicate. In addition, the computer 1020, which has its own processor, may incorporate the components of the client device 1140, or may be the client device 1140.

The phone segment 3040 looks like a telephone keypad and contains numbers that a customer can use to dial a telephone number. The phone segment 3040 may also include buttons for other telephone features such a mute and hold. The phone segment 3040 may also have buttons to send and to end a call.

The contact list segment 3060 includes a list of names and phone numbers. As will be described in further detail below, the names and phone numbers may be names and phone numbers that were input by the customer or they may be names and phone numbers that were automatically sent to the client device 1140 or associated computer 1020 in the manner described below. When the softphone user interface 3000 is first generated, the entries for the contact list may be retrieved from memory 2200 or may be retrieved from a server via a network.

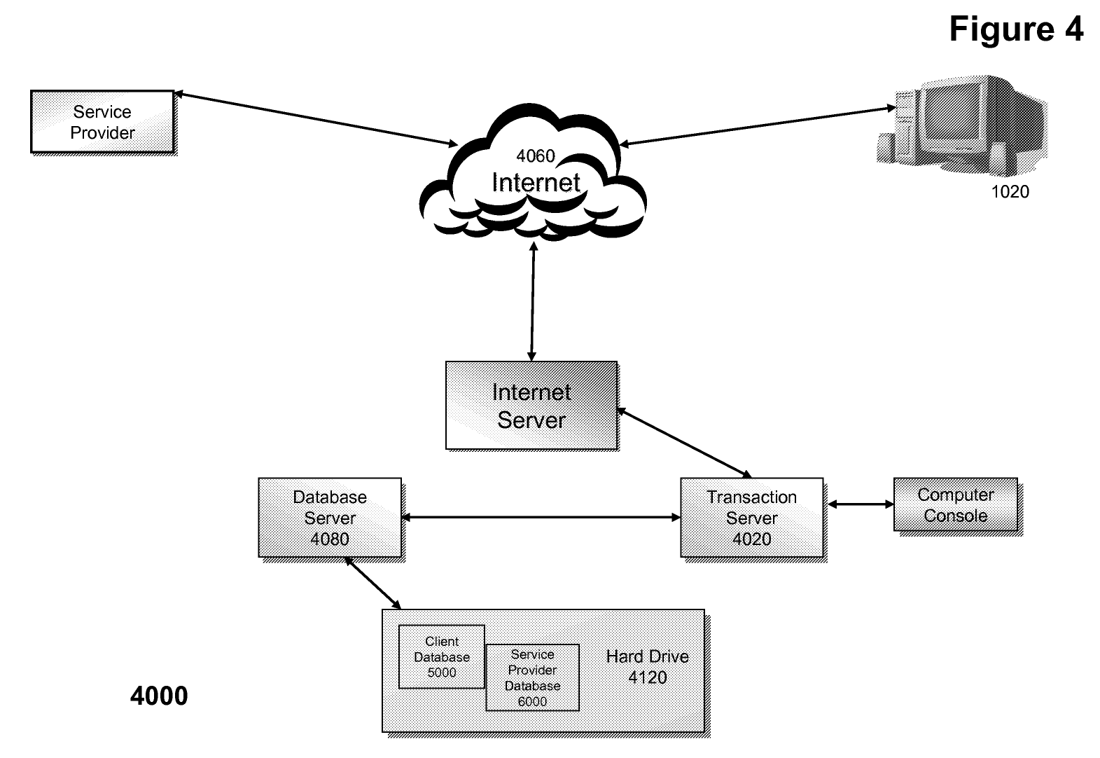

FIG. 4 depicts a network environment 4000 in which a client device 1140 of present invention may be employed. Once the softphone is running on the computer, the computer sends a unique client identifier to a transaction server 4020 via a communications or data network, which may include a packet switched network, such as the Internet 4060, and/or an internet server. The client device 1140 connects to the transaction server 4020 via the network 4060 and relies on the transaction server 4020 to deliver information to the user's computer 1020. In a preferred embodiment, the protocol used to communicate with the computer 1020 implementing the softphone is hypertext transfer protocol (“HTTP”). The HTTP instructions are sent across the network (e.g., Internet 4060) via Transmission Control Protocol/Internet Protocol (TCP/IP), which breaks the data into packets and recombines them on the receiving computer, whether client or server. The unique client identifier can be the serial number of the client device 1140, a password associated with the client device 1140, the customer's telephone number associated with the client device 1140, a username associated with the client device 1140, or any other information specific or unique to the client device 1140 or customer using the client device 1140. In a preferred embodiment, the unique customer identifier is the serial number associated with the client device 1140 that is stored in the memory 2200 of the client device 1140.

The transaction server 4020 utilizes the serial number to query a database of a database server 4080. In one embodiment, the serial number is queried against a client database 5000 that contains a field for determining client authorization. In an alternative embodiment, the serial number is queried against a designated authorization database (not shown). The data of the client database 5000 can reside on a hard drive 4120 coupled to the database server 4080. Alternatively, the client database 5000 may be stored on multiple hard drives, which may include hard drives presented in a RAID configuration. Preferably, the client database 5000 is a relational database. In an alternative embodiment, the serial number is queried against a designated authorization database (not shown).

If one or more records contain the serial number and an indication that the serial number is authorized, then location identifying information associated with the client device 1140 (or user of the device) is retrieved from the database record. The location identifying information can be any information that indicates the geographic location of the customer. For example, the customer's location identifying information can be the customer's zip code, the customer's municipality, the customer's state, the customer's street address, or the customer's area code. The customer's location identifying information may also be a market zone, which is a specific area within a particular radius, but not measured solely by a fixed boundary such as a town or zip code. The scope of the market zone may be determined with reference to GPS location information or longitude and latitude location information that is included in the location identifying information stored within the client database 5000. Geospatial information, such as latitude and longitude, is available via a number of publicly accessible sources. One example of a source that may be found on the Internet is Google™ Maps. By way of example, the market zone may be defined to encompass a region that is substantially a circle whose radius is measured from the longitude and latitude location information included within the location identifying information of the database record that is being queried. The scope of the market zone may also be determined with reference to shopping or delivery or other affinity areas related to street address or other information stored within the client database 5000.

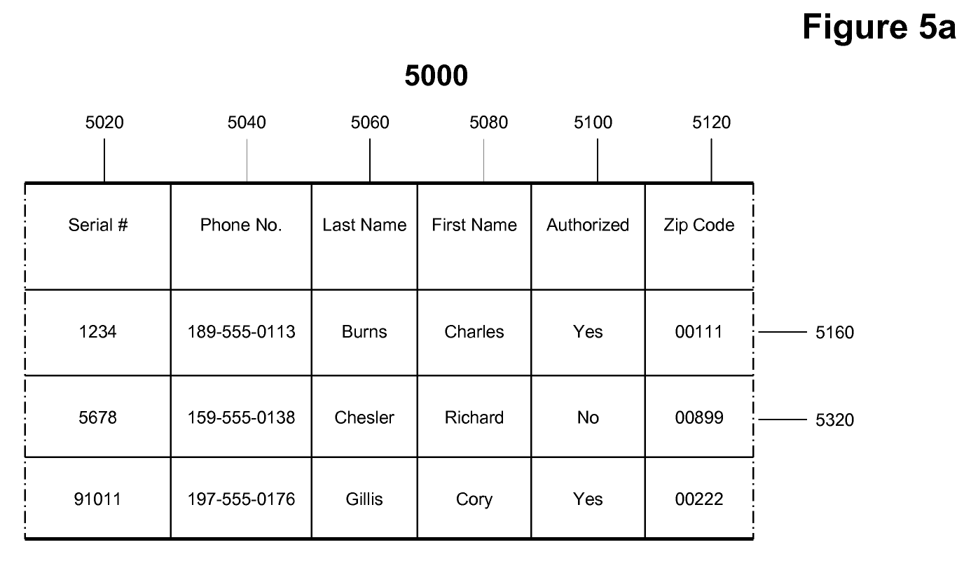

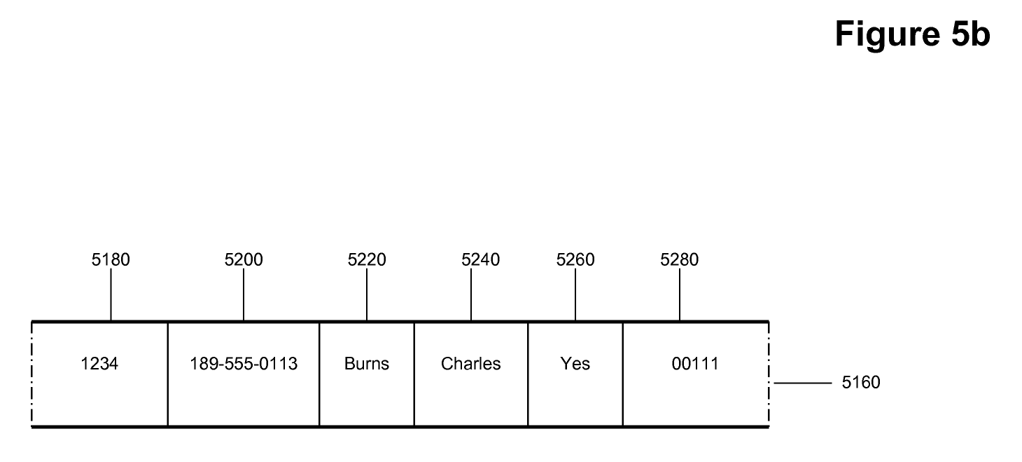

FIG. 5a illustrates one example of a table from the client database 5000 that is a relational database. The client database 5000 contains columns for the unique client identifier, in this case, the serial number of the client device employed by a user 5020, a customer's phone number 5040, the customer's last name 5060, the customer's first name 5080, a column for authorization 5100, and a column for the customer location identifying information, in this case, the customer's zip code 5120.

The client database 5000 also contains rows, each of which contain the information stated in the columns relating to a specific customer's information. For example, the first row 5160 contains information regarding a hypothetical customer named Charles Burns.

As shown in FIG. 5b, the first cell 5180 of the first row contains the serial number of the client device being used by Mr. Burns, “1234.” The second cell 5200 of the first row contains Mr. Burns' phone number “189-555-0113.” The third cell 5220 of the first row contains Mr. Burns' last name, “Burns.” The fourth cell 5240 of the first row contains Mr. Burns' first name, “Charles.” The fifth cell 5260 of the first row contains an entry noting that Mr. Burns is authorized to use the system by indicating a “Yes.” The sixth cell 5280 of the first row contains Mr. Burns' zip code “00111.”

Similarly, as shown in FIG. 5a, the second row 5320, for example, contains information regarding a hypothetical customer named Richard Chesler. The first cell of the second row contains the serial number of the client device being used by Mr. Chesler, “5678.” The second cell of the second row contains Mr. Chesler's phone number “159-555-0138.” The third cell of the second row contains Mr. Chesler's last name, “Chesler.” The fourth cell of the second row contains Mr. Chesler's first name, “Richard.” The fifth cell of the second row contains an entry noting that Mr. Chesler is not authorized to use the system by indicating a “No.” The sixth cell of the second row contains Mr. Chesler's zip code “00899.”

The results of the search for the customer's location identifying information are then queried against a service provider database 6000. The data of the service provider database 6000 can reside on the hard drive 4120 coupled to the database server 4080, or it may reside on a different hard drive associated with the same database server or a different database server. Alternatively, the data of the service provider database 6000 may be stored on multiple hard drives, which may include hard drives presented in a RAID configuration. Preferably, the service provider database 6000 is a relational database.

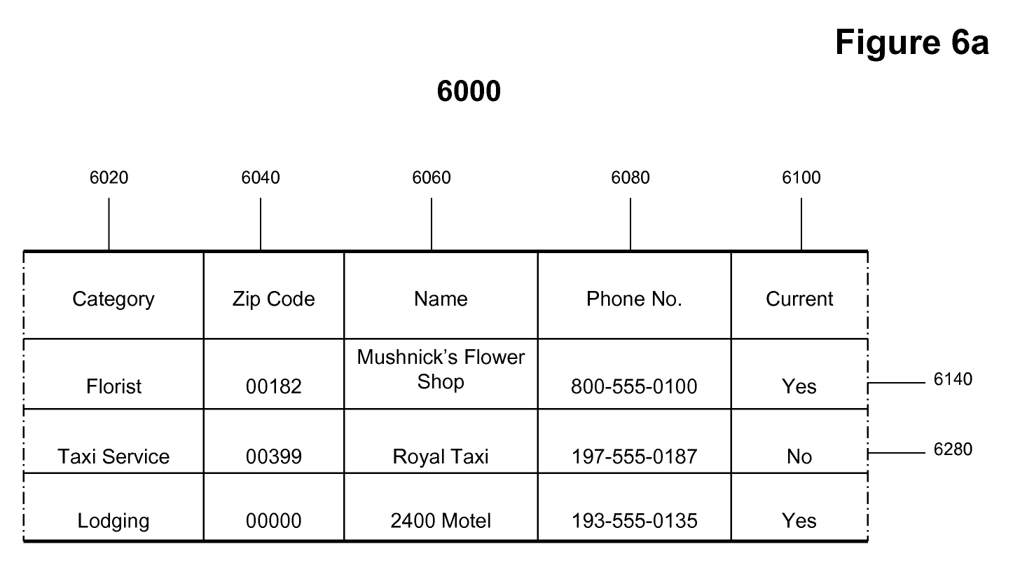

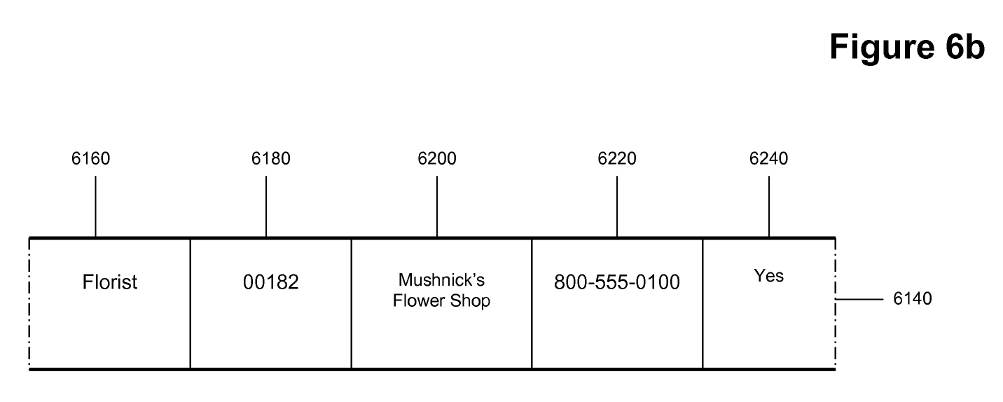

FIG. 6a illustrates one example of a table of the service provider database 6000 that may be employed in connection with an embodiment of the present invention. The service provider database 6000 is a relational database and contains columns for the service provider category 6020, location identifier, in this case, service provider zip code 6040, name 6060, phone number 6080, and an indication of whether the service provider is current in payment 6100.

The service provider database 6000 also contains rows, each of which contain the information stated in the columns relating to a specific service provider's information for one location (e.g., retail location). For example, the first row 6140, contains information regarding a service provider hypothetically named “Mushnick's Flower Shop.”

As shown in FIG. 6b, the first cell 6160 of the first row contains the business category in which Mushnick's Flower Shop falls, “Florist.” The second cell 6180 of the first row contains Mushnick's Flower Shop's zip code, “00182.” The third cell 6200 of the first row contains Mushnick's Flower Shop's name, “Mushnick's Flower Shop.” The fourth cell 6220 of the first row contains Mushnick's Flower Shop's phone number, “800-555-0100.” The fifth cell 6240 of the first row contains an indication that Mushnick's Flower Shop is current in their payment, designated by a “Yes.”

Similarly, as shown in FIG. 6a, the second row 6280, for example, contains information regarding a service provider hypothetically named “Royal Taxi.” The first cell of the second row contains the business category in which Royal Taxi falls, “Taxi Service.” The second cell of the second row contains Royal Taxi's zip code “00399” The third cell of the second row contains Royal Taxi's name, “Royal Taxi.” The fourth cell of the second row contains Royal Taxi's phone number, “197-555-0187.” The fifth cell of the second row contains an indication that Royal Taxi is not current in their payment, designated by a “No.”

Specifically, a customer's zip code is compared by the transaction server's processor 4020 to the contents of the cells holding service provider zip codes 6040 and service providers that have zip codes corresponding to the customer's zip code is identified on a location by location basis. In alternative embodiments of the invention, other customer location indicators and/or other service provider information may be used for the comparison, such as the customer's and service provider's street addresses, municipalities, states, longitude and latitude information, and global positioning system coordinates.

In accordance with the present invention, the computer 1020 coupled to the client device 1140 can populate the contact list after receiving service provider information, including a service provider phone number, from the transaction server 4020. Alternatively, the transaction server 4020 can populate a contact list with service provider entries and forward the list to the computer 1020 coupled to the client device 1140. In any event, information received from the service provider will be sent via the network 4060 to the computer 1020 coupled to the client device 1140 in the form of a file. By way of example, the file may be a file with an .ini extension.

If the computer 1020 coupled to the client device 1140 is populating the contact list, it will examine the service provider information received from the transaction server 4020 to see if it already has that information reflected in an entry corresponding to the service provider. If it does not have that service provider information, then it will update the contact list with one or more entries corresponding to that service provider information. Otherwise, if it does have that service provider information already reflected in the contact list, then it will not update the list to reflect that information.

It may be the case that the contents of an existing service provider record in the service provider database 6000 needs to be changed. In that case, a change record status flag may be used to indicate the presence of a change to an existing record so that the record will not be identified as a duplicate of a previous version of the record whose contents had been sent to the client device 1140 or first processor device.

Similarly, flags may be used to reflect whether a service provider has paid fees for populating contact lists with entries that reflect locations where the service providers may be contacted. If the service provider has paid the fees, then a flag will indicate that the service provider has done so and when the contact list is updated, those entries for that service provider will be displayed accordingly. If the flag is not set, then the service provider has not paid and their corresponding entries in the contact list will not be displayed.

In one embodiment, a user of the contact list can indicate that an entry in the contact list should not be removed, for example, by editing the entry or otherwise marking it. A flag will then be set in the contact list to reflect that the entry will not be deleted.

Conversely, a user can designate an entry in the contact list for deletion. Accordingly, a flag will be set and the entry will be maintained in the contact list but not displayed. This ensures that the entry will not be downloaded again in the contact list because it is not actually deleted. When entries are checked for duplicates, the entries marked for deletion will still exist (but not be displayed) so the entry will not be repopulated in the contact list.

If the transaction server 4020 is populating the contact list, then it will store the latest version of the contact list in its client or customer database 5000 and check to see whether any service provider information retrieved from the service provider database 6000 is redundant of information already reflected in the contact list. If it is, then that entry of the contact list will not be updated. If it is not, then one or more new entries will be created for the contact list that correspond to that service provider information.

When the contact list is selected in the softphone user interface 3060, the user will see, in addition to any entries that he had added or imported himself, entries for service providers. In a preferred embodiment of the invention, the entries will be for businesses in the customer's local area. Also, it may be the case that only a predetermined number of entries for service providers may be included in a user's contact list. In that case, the service provider entries will be prioritized either before they are sent to the client device, or thereafter, in accordance with one or more predefined rules. By way of example, if a service provider pays the most amount of money for inclusion of one or more of their entries, then their entries shall be included first in the list. If two providers have paid the same for their entry, then the one who has been paying for service provider entries the longest will get their service provider entry included higher on the list. If the predetermined number of entries is met, then the highest paying service providers will be included. In an alternative embodiment, the highest paying service provider(s) in each category will be included.

In one embodiment of the invention, the service provider entries also include the service provider's business category. In a preferred embodiment, the service provider entries are listed alphabetically, by business category. In one embodiment, the service provider entries will be listed in the same contact list as the customer's personal entries. In this embodiment, the service provider entries they may be clustered together at the top of the listings or at the bottom of the listings. In another embodiment, the entries may be interspersed with the customer's personal entries, either in alphabetical order using the service provider's company name or a business category, such as a category or categories of goods and/or services provided by the service provider (e.g., “Florist,” “Taxi Service,” “Lodging,” etc.).

In another embodiment, the service provider entries are listed in a contact list separate from the customer's personal contact list. In this embodiment, the contact list segment 3060 of the softphone user interface 1160 may display one of the contact lists (such as the service provider contact list) and contain a link to switch to another contact list, such as a user's personal contact list.

In accordance with the present invention, once the service provider entries are listed in a user's contact list, the user can click on a service provider's entry and information about the service provider will appear on the screen. In one embodiment, the service provider's phone number appears. In another embodiment, the service provider's address appears. In other embodiments, additional information may appear, such as a description of services, hours of operation, pricing, menus, or other information related to the service provider. In the foregoing embodiments, the customer can push a button or click on a link to have the call automatically placed via a telephony service, such as a VoIP service.

In accordance with the invention, each time a user logs into the VoIP system, his contact list will be updated with new entries from new service providers. In another embodiment, the user will have the option of manually deleting specific service provider's entries. In another embodiment, previously deleted entries will not be re-added to the customer's contact list. In another embodiment, previously deleted entries will be re-added to the customer's contact list when the contact list is repopulated.

When the customer moves to a different geographical location (either permanently or temporarily) the customer may store his new geographical information (e.g., a new zip code) in the memory of the client device 1140 or associated computer 1020. Thereafter, contact information from service providers in the customer's new location will be automatically added to the customer's contact list. In one embodiment of the invention, the new entries will replace the old entries. In another embodiment, the new entries will be cumulative to the old entries. In another embodiment, the new entries will be cumulative, but appear in a separate geographical listing. In another embodiment, the customer will have the option of whether to replace old entries with new entries or to make them cumulative. In still another embodiment, the customer will have the option of making the new entries temporary or permanent.

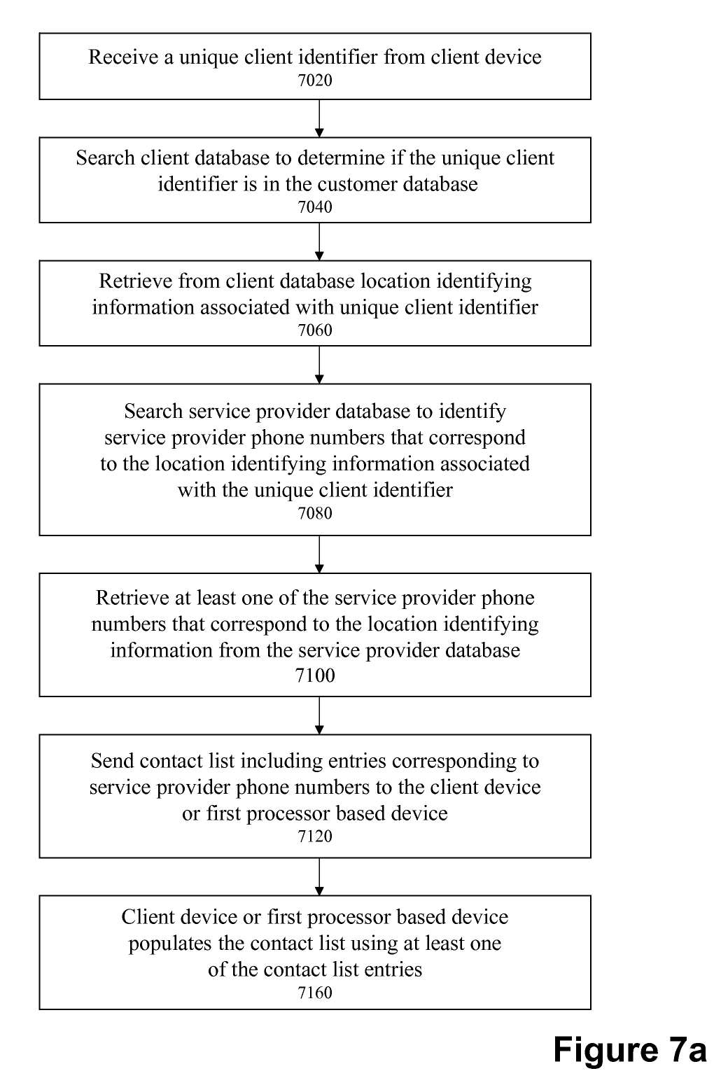

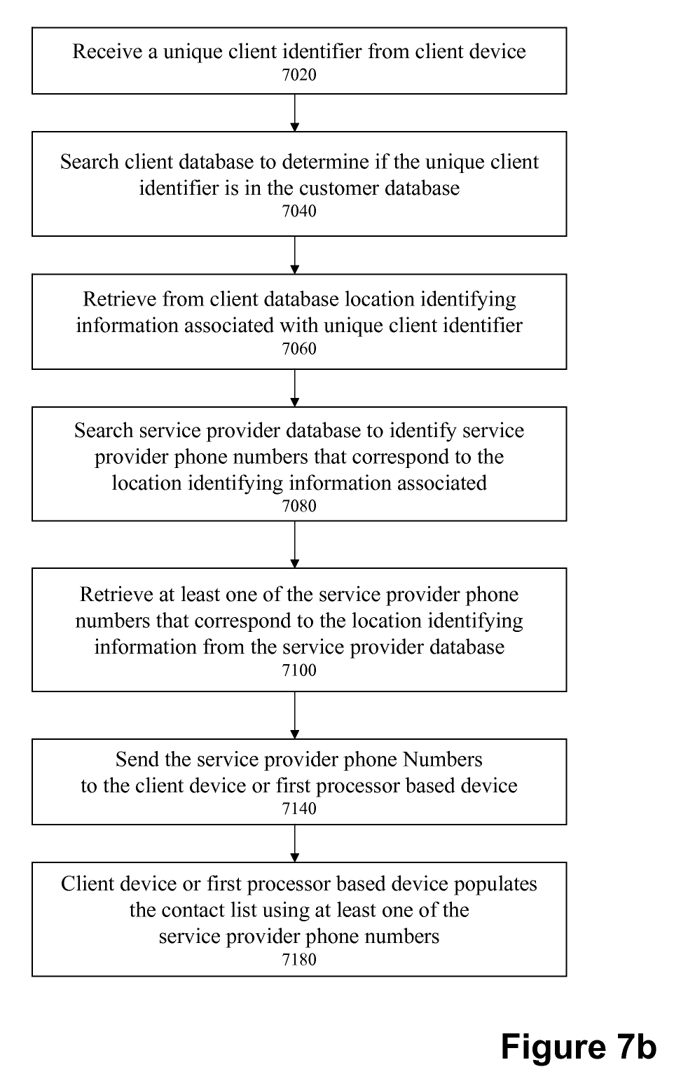

FIGS. 7a and 7b illustrate processes for populating a contact list using a client device from the perspective of a server. The client device can be any device that alone, or in combination with another device, is capable of storing and running softphone software. Examples of possible client devices include a USB device, a DECT phone, a cellular phone, and a computer. In a preferred embodiment, the client device is a USB device. The client device is coupled to a first processor based device, which can be a computer, for example.

The first processor-based device may be coupled to the second processor-based device via at least one communications network or at least one data network, such as a packet-switched network. In a preferred embodiment, communication between the first processor-based device and the second processor-based device is by HTTP and is implemented via TCP/IP protocol.

The process includes receiving a unique client identifier from the client device 7020. The unique client identifier can be any information that identifies a particular customer or client device, for example, a client device serial number, a customer phone number, an Internet Protocol Address, or a network interface code. A password may also be associated with the unique client identifier. In a preferred embodiment, the unique client identifier is a client device serial number, which may or may not be coupled with a password.

The next step of the process includes conducting a first search of a client database to determine if the unique client identifier is present in the client database 7040. The client database may contain one table that includes all of the customer's information, or it can contain multiple tables with each table having different pieces of the customer's information. In a preferred embodiment, the client database is a relational database. The data associated with the client database may be stored in a memory, which may be accessible by a second processor-based device. In one embodiment, the customer information can be input into the client database upon receipt from the client device or associated computer.

In a further embodiment, the process includes searching the database to determine whether the customer or device associated with the unique client identifier is authorized to use the system. If the unique client identifier is not found in the database, then a message may be sent to the client device instructing it, for example, to cease operation.

The process continues by retrieving from the client database, location identifying information associated with the unique client identifier 7060. Location identifying information may be any information that associates a particular customer or client device with a particular geographic area, for example, a zip code, state, municipality, street address, latitude and longitude coordinates, global positioning system coordinates, or information defining an area based on certain market characteristics. In a preferred embodiment, location identifying information is latitude and longitude coordinates associated with the customer's location. In a further embodiment, the process includes retrieving demographic information associated with the customer, such as age, employment status, gender, income, and/or marital status, from the client database.

The process continues by searching a service provider database to identify service provider phone numbers that correspond to the location identifying information associated with the unique client identifier 7080. The service provider database contains, at a minimum, service provider phone numbers. In a preferred embodiment, the service provider database also contains service provider names and business categories. In addition, the service provider database may contain other service provider information, such as service provider addresses, service provider advertisements, information specific to service provider businesses, links to service provider websites, and links to service provider phone numbers.

In a preferred embodiment, the service provider database is a relational database. The data of the service provider database may be stored in a memory, which may be accessible by a second processor-based device. In a preferred embodiment, the client database and the service provider database are one database containing separate tables for customer information and service provider information. Other configurations, however, are certainly possible, for example, the client database and the service provider database may be separate databases; the information for the client database and the information for the service provider database may be in the same table on the same database; or the information for both the client database and the service provider database may be split among several databases, which could be located on one or more processor-based devices.

In a further embodiment, the determination of whether the service provider phone numbers correspond to the location identifying information may be based on whether the service provider phone numbers are associated with the same specific information as reflected in the location identifying information. The specific information can include information such as zip code, state, municipality, street address, latitude and longitude coordinates, global positional system coordinates, and information defining an area based on certain market characteristics.

In a still further embodiment, the determination may be based on whether the service provider phone numbers are associated with a first zip code included within a first group of zip codes that also includes a second zip code reflected in the location identifying information. A determination may also be based on whether the service provider phone numbers are associated with a geographic area (defined by a predetermined set of market characteristics) that is also associated with the location identifying information. The predetermined set of market characteristics may include certain demographic information, such as average earnings per capita, the average home price in the geographic area under consideration, or shopping or delivery or other affinity areas.

The next step includes retrieving at least one of the service provider phone numbers that correspond to the location identifying information from the service provider database 7100. In further embodiments, additional service provider information, such as that discussed above, may also be retrieved. In still another further embodiment, at least one service provider phone number that corresponds to both location identifying information and demographic information may be retrieved.

Next, as shown in FIG. 7a, in one embodiment, the process includes sending the contact list, including entries corresponding to service provider phone numbers, to the client device or first processor based device 7120. In an alternative embodiment, as shown in FIG. 7b, the process includes sending the service provider phone numbers to the client device or first processor based device 7140.

In further embodiments, the process may also include determining if any of the service provider phone numbers that have been retrieved from the service provider database or sent to the client device or first processor based device are duplicative of those previously sent. Only those service provide phone numbers that are not duplicative will be retrieved or sent to the client device or first processor based device.

In the embodiment shown in FIG. 7a, the client device or first processor based device then populates the contact list using at least one of the contact list entries 7160. Alternatively, in the embodiment shown in FIG. 7b, the client device or first processor based device populates the contact list using at least one of the service provider phone numbers 7180. The client device or first processor based device may also use the additional service provider information if such information was sent. In a further embodiment, the client device or first processor-based device may include in the contact list only certain service provider phone numbers, for example, it may include only numbers that have not been sent previously.

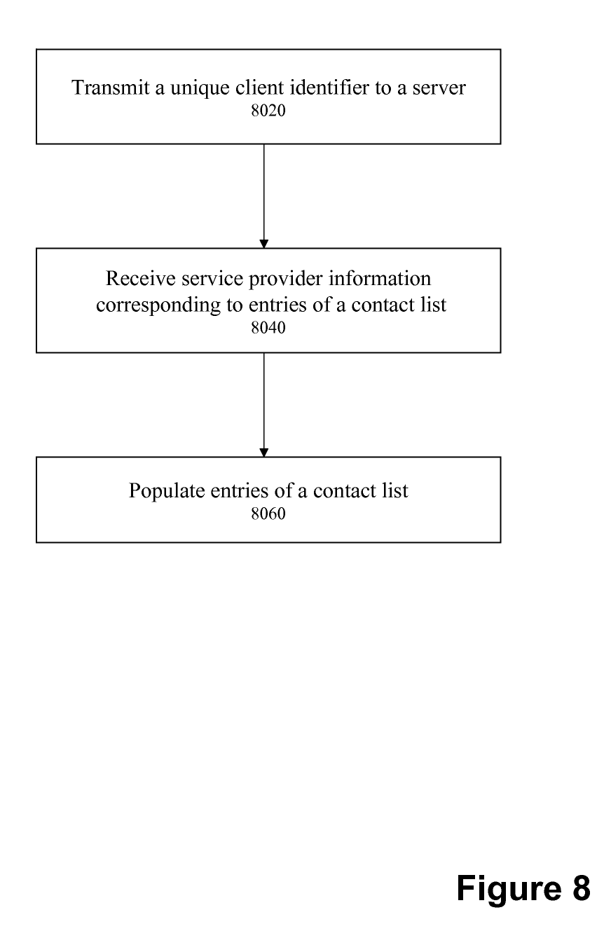

FIG. 8 illustrates a process for populating a contact list for a client device from the perspective of a client device. The client device can be any device that alone, or in combination with another device, is capable of storing and running softphone software. Examples of possible client devices include a USB device, a DECT phone, a cellular phone, and a computer. In a preferred embodiment, the client device is a USB device. The client device is coupled to a first processor based device, which can be a computer.

The process includes transmitting a unique client identifier to a server 8020. The unique client identifier can be any information that identifies a particular customer or client device, for example, a client device serial number, a customer phone number, an Internet Protocol Address, or a network interface code. A password may also be associated with the unique client identifier. In a preferred embodiment, the unique client identifier is a client device serial number which may or may not be coupled with a password.

The client device may be coupled to the server via at least one communications or data network, such as a packet-switched network. In a preferred embodiment, communication between the client device and the server is by HTTP and is implemented via TCP/IP protocol.

The server is adapted to provide customer location identifying information corresponding to the unique client identifier. The customer location identifying information can be any information that associates the customer or client device with a particular geographic area, for example, a zip code, state, municipality, street address, latitude and longitude coordinates, global positioning system coordinates, or information defining an area based on certain market characteristics. In a preferred embodiment, location identifying information is latitude and longitude coordinates associated with the customer's location. In a further embodiment, demographic information, such age, employment status, gender, income, and/or marital status, may also be associated with the unique client identifier.

In another embodiment, service provider phone numbers may correspond to the location identifying information if the service provider phone numbers are associated with the same zip code as reflected in the location identifying information. In yet another embodiment, service provider phone numbers correspond to the location identifying information if the service provider phone numbers are associated with the same specific information as reflected in the location identifying information. The specific information can include information such as zip code, state, municipality, street address, latitude and longitude coordinates, global positional system coordinates, and information defining an area based on certain market characteristics. In still another embodiment, service provider phone numbers may correspond to the location identifying information if the service provider phone numbers are associated with a first zip code that is included within a first group of zip codes that also includes a second zip code reflected in the location identifying information. In yet another embodiment, the service provider phone numbers may correspond to the location identifying information if the service provider phone numbers are associated with a geographic area that is also associated with the location identifying information. The geographic area may be defined by a predetermined set of market characteristics that may include certain demographic information, such as average earnings per capita, the average home price in the geographic area under consideration, or shopping or delivery or other affinity areas.

The next step includes receiving service provider information corresponding to entries of a contact list 8040. The entries include service provider phone numbers corresponding to the customer location identifier. In a preferred embodiment, the entries include the names and business categories of the service providers. In another embodiment, the entries include additional information about the service providers such as service provider addresses, service provider advertisements, information specific to service provider businesses, links to service provider websites, and links to service provider phone numbers.

In one embodiment, only those entries that are not duplicative of entries already received by the client device are received. In another embodiment, only those entries which are not duplicative of entries previously sent to the client device are received.

The final step includes populating entries of a contact list 8060. In a preferred embodiment, all entries are received by the client device, but only those entries which were not previously received or previously used to populate the contact list will be use to populate the contact list. In one embodiment, the client device searches the contact list for entries matching the entries received from the service provider database. Only those entries that are not already included in the contact list will be used to populate the contact list. In another embodiment, the client device searches the contact list for entries that were previously included in the contact list but were subsequently deleted or hidden by the customer. Such entries will not be used to populate the contact list.

In a further embodiment, the client device searches the contact list to determine if it contains any service provider entries that were not received pursuant to the most recent update. In one embodiment, such entries will be removed from the contact list. In another embodiment, the client device will further determine if such entries have been manipulated by the customer (e.g., contain flags), and if they have, they will not be removed.

Although different embodiments of the present invention have been discussed, those skilled in the art will appreciate that variations may be made thereto without departing from the principles of the present invention. By way of example, the techniques described above may be used to populate the above-referenced service provider segment with specific advertisements. In addition, although the preferred embodiment has been described, different embodiments may be designed which do not include all of those features, and yet still fall within the spirit and scope of the present invention.

What is claimed is:

1. A process for populating a contact list using a client device coupled to a first processor based device, said process comprising:
(i) receiving a unique client identifier from said client device;
(ii) conducting a first search of a client database to determine if said unique client identifier is present in said client database;
(iii) retrieving from said client database location identifying information associated with said unique client identifier, if a determination is made that said unique client identifier is present in said client database;
(iv) searching a service provider database to identify service provider phone numbers that correspond to said location identifying information associated with said unique client identifier;
(v) retrieving at least one of said service provider phone numbers that correspond to said location identifying information from said service provider database; and then
(vi) sending said at least one of said service provider phone numbers to said client device, such that said client device implements said contact list using said at least one of said service provider phone numbers.

2. The process of claim 1, wherein said unique client identifier comprises a customer identifier.

3. The process of claim 1, wherein said unique client identifier comprises a serial number associated with said client device.

4. The process of claim 1, wherein said unique client identifier further comprises a password.

5. The process of claim 1, wherein said unique client identifier comprises a customer phone number.

6. The process of claim 1, wherein said unique client identifier comprises an Internet Protocol Address.

7. The process of claim 1, wherein said unique client identifier is a network interface code.

8. The process of claim 1, wherein data of said client database and service provider database are stored in a memory accessible by a second processor-based device.

9. The process of claim 1, wherein said first processor-based device is coupled via at least one communications network to said second processor-based device.

10. The process of claim 1, wherein said first processor-based device is coupled via at least one data network to said second processor-based device.

11. The process of claim 10 wherein said data network is a packet-switched network.

12. The process of claim 1, wherein said client device comprises a USB device.

13. The process of claim 1, wherein said client device comprises a DECT phone.

14. The process of claim 1, wherein said client device comprises a cellular phone.

15. The process of claim 1, further comprising a step of determining whether said unique client identifier is an authorized unique client identifier.

16. The process of claim 1, wherein said location identifying information comprises a zip code.

17. The process of claim 1, wherein said location identifying information comprises a state.

18. The process of claim 1, wherein said location identifying information comprises a municipality.

19. The process of claim 1, wherein said location identifying information comprises a street address.

20. The process of claim 1, wherein said location identifying information comprises latitude and longitude coordinates.

21. The process of claim 1, wherein said location identifying information comprises global positioning system coordinates.

22. The process of claim 1, wherein said location identifying information comprises information defining an area based on certain market characteristics.

23. The process of claim 1, further comprising a step of retrieving demographic information associated with said unique client identifier from said client database.

24. The process of claim 23, wherein said demographic information comprises the age of a person.

25. The process of claim 23, wherein said demographic information comprises the employment status of a person.

26. The process of claim 23, wherein said demographic information comprises the gender of a person.

27. The process of claim 23, wherein said demographic information comprises the income of a person.

28. The process of claim 23, wherein said demographic information comprises the marital status of a person.

29. The process of claim 23, further comprising retrieving at least one of said service provider phone numbers that correspond to both said location identifying information and said demographic information from said service provider database.

30. The process of claim 1, further comprising determining whether said service provider phone numbers correspond to said location identifying information based on whether said service provider phone numbers are associated with the same zip code as reflected in said location identifying information.

31. The process of claim 1, further comprising determining whether said service provider phone numbers correspond to said location identifying information based on whether said service provider phone numbers are associated with the same state as reflected in said location identifying information.

32. The process of claim 1, further comprising determining whether said service provider phone numbers correspond to said location identifying information based on whether said service provider phone numbers are associated with the same municipality as reflected in said location identifying information.

33. The process of claim 1, further comprising determining whether said service provider phone numbers correspond to said location identifying information based on whether said service provider phone numbers are associated with the same street address as reflected in said location identifying information.

34. The process of claim 1, further comprising determining whether said service provider phone numbers correspond to said location identifying information based on whether said service provider phone numbers are associated with the same latitude and longitude coordinates as reflected in said location identifying information.

35. The process of claim 1, further comprising determining whether said service provider phone numbers correspond to said location identifying information based on whether said service provider phone numbers are associated with the same global positional system coordinates as reflected in said location identifying information.

36. The process of claim 1, further comprising determining whether said service provider phone numbers correspond to said location identifying information based on whether said service provider phone numbers are associated with the same information defining an area based on certain market characteristics as reflected in said location identifying information.

37. The process of claim 1, further comprising determining whether said service provider phone numbers correspond to said location identifying information based on whether said service provider phone numbers are associated with a first zip code included within a first group of zip codes that also includes a second zip code reflected in said location identifying information.

38. The process of claim 1, further comprising determining whether said service provider phone numbers correspond to said location identifying information based on whether said service provider phone numbers are associated with a geographic area that is also associated with said location identifying information, said geographic area being defined by a predetermined set of market characteristics.

39. The process of claim 1, further comprising the step of determining if any of said service provider phone numbers that have been retrieved are duplicative of a set of service provider phone numbers previously sent to said client device to facilitate populating said contact list.

40. The process of claim 39, wherein the step of sending comprises sending only those service provider phone numbers that are not duplicative of a set of service provider phone numbers previously sent to said client device to facilitate populating said contact list.

41. The process of claim 1, further comprising the step of determining if any of said service provider numbers are duplicative of a set of service provider phone numbers previously sent to said client device to facilitate populating said contact list.

42. The process of claim 41, wherein said step of retrieving comprises retrieving only those service provider phone numbers which are not duplicative of a set of service provider phone numbers previously sent to said client device to facilitate populating said contact list.

43. The process of claim 1, wherein communication between said first processor-based device and said second processor-based device is by hypertext transfer protocol.

44. The process of claim 1, wherein communication between said first processor-based device and said second processor-based device is implemented via TCP/IP protocol.

45. The process of claim 1, wherein said customer information is input into client database upon receipt from said client device.

46. The process of claim 1, wherein said retrieving further comprises retrieving service provider information, wherein said service provider information includes one or more of the following:
(i) one or more service provider categories;
(ii) one or more a service provider names;
(iii) one or more service provider addresses;
(iv) one or more service provider phone numbers;
(v) one or more service provider advertisements;
(vi) information specific to one or more service providers' business;
(vii) one or more link to service providers' websites; and
(viii) one or more link to one or more service providers' phone number.

47. The process of claim 46, wherein said sending further comprises sending said service provider information.

48. The process of claim 1, wherein said contact list includes service provider information, wherein said service provider information includes one or more of the following:
(i) one or more service provider categories;
(ii) one or more a service provider names;
(iii) one or more service provider addresses;
(iv) one or more service provider phone numbers;
(v) one or more service provider advertisements;
(vi) information specific to one or more service providers' business;
(vii) one or more link to service providers' websites; and
(viii) one or more link to one or more service providers' phone number.

49. The process of claim 1, wherein said client database is a relational database.

50. The process of claim 1, wherein said service provider database is a relational database.

51. A process for populating a contact list for a client device coupled to a first processor based device, said process comprising:
receiving a unique client identifier from said client device;
conducting a first search of a client database to determine if said unique client identifier is present in said client database;
retrieving from said client database location identifying information associated with said unique client identifier, if a determination is made that said unique client identifier is present in said client database;
searching a service provider database to identify service provider phone numbers that correspond to said location identifying information associated with said unique client identifier;
retrieving at least one of said service provider phone numbers that correspond to said location identifying information from said service provider database; and then
sending said at least one of said service provider phone numbers to said first processor based device, such that said first based processor device implements said contact list using said at least one of said service provider phone numbers.

52. The process of claim 51, wherein said unique client identifier comprises a customer identifier.

53. The process of claim 51, wherein said unique client identifier comprises a serial number associated with said client device.

54. The process of claim 51, wherein said unique client identifier further comprises a password.

55. The process of claim 51, wherein said unique client identifier is a customer phone number.

56. The process of claim 51, wherein said unique client identifier is an Internet Protocol Address.

57. The process of claim 51, wherein said unique client identifier is a network interface code.

58. The process of claim 51, wherein data of said client database and service provider database are stored in a memory accessible by a second processor-based device.

59. The process of claim 51, wherein said first processor-based device is coupled via at least one communications network to said second processor-based device.

60. The process of claim 51, wherein said first processor-based device is coupled via at least one data network to said second processor-based device.

61. The process of claim 60, wherein said data network is a packet-switched network.

62. The process of claim 51, wherein said client device comprises a USB device.

63. The process of claim 51, wherein said client device comprises a DECT phone.

64. The process of claim 51, wherein said client device comprises a cellular phone.

65. The process of claim 51, further comprising a step of determining whether said unique client identifier is an authorized unique client identifier.

66. The process of claim 51, wherein said location identifying information comprises a zip code.

67. The process of claim 51, wherein said location identifying information comprises a state.

68. The process of claim 51, wherein said location identifying information comprises a municipality.

69. The process of claim 51, wherein said location identifying information comprises a street address.

70. The process of claim 51, wherein said location identifying information comprises latitude and longitude coordinates.

71. The process of claim 51, wherein said location identifying information comprises global positioning system coordinates.

72. The process of claim 51, wherein said location identifying information comprises information defining an area based on certain market characteristics.

73. The process of claim 51, further comprising a step of retrieving demographic information associated with said unique client identifier from said client database.

74. The process of claim 73, wherein said demographic information comprises the age of a person.

75. The process of claim 73, wherein said demographic information comprises the employment status of a person.

76. The process of claim 73, wherein said demographic information comprises the gender of a person.

77. The process of claim 73, wherein said demographic information comprises the income of a person.

78. The process of claim 73, wherein said demographic information comprises the marital status of a person.

79. The process of claim 73, further comprising retrieving at least one of said service provider phone numbers that correspond to both said location identifying information and said demographic information from said service provider database.

80. The process of claim 51, further comprising determining whether said service provider phone numbers correspond to said location identifying information based on whether said service provider phone numbers are associated with the same zip code as reflected in said location identifying information.

81. The process of claim 51, further comprising determining whether said service provider phone numbers correspond to said location identifying information based on whether said service provider phone numbers are associated with the same state as reflected in said location identifying information.

82. The process of claim 51, further comprising determining whether said service provider phone numbers correspond to said location identifying information based on whether said service provider phone numbers are associated with the same municipality as reflected in said location identifying information.

83. The process of claim 51, further comprising determining whether said service provider phone numbers correspond to said location identifying information based on whether said service provider phone numbers are associated with the same street address as reflected in said location identifying information.

84. The process of claim 51, further comprising determining whether said service provider phone numbers correspond to said location identifying information based on whether said service provider phone numbers are associated with the same latitude and longitude coordinates as reflected in said location identifying information.

85. The process of claim 51, further comprising determining whether said service provider phone numbers correspond to said location identifying information based on whether said service provider phone numbers are associated with the same global positional system coordinates as reflected in said location identifying information.

86. The process of claim 51, further comprising determining whether said service provider phone numbers correspond to said location identifying information based on whether said service provider phone numbers are associated with the same information defining an area based on certain market characteristics as reflected in said location identifying information.

87. The process of claim 51, further comprising determining whether said service provider phone numbers correspond to said location identifying information based on whether said service provider phone numbers are associated with a first zip code included within a first group of zip codes that also includes a second zip code reflected in said location identifying information.

88. The process of claim 51, further comprising determining whether said service provider phone numbers correspond to said location identifying information based on whether said service provider phone numbers are associated with a geographic area that is also associated with said location identifying information, said geographic area being defined by a predetermined set of market characteristics.

89. The process of claim 51, further comprising the step of determining if any of said service provider phone numbers that have been retrieved are duplicative of a set of service provider phone numbers previously sent to said client device to facilitate populating said contact list.

90. The process of claim 89, wherein the step of sending comprises sending only those service provider phone numbers that are not duplicative of a set of service provider phone numbers previously sent to said client device to facilitate populating said contact list.

91. The process of claim 51, further comprising the step of determining if any of said service provider numbers are duplicative of a set of service provider phone numbers previously sent to said client device to facilitate populating said contact list.

92. The process of claim 91, wherein said step of retrieving comprises retrieving only those service provider phone numbers which are not duplicative of a set of service provider phone numbers previously sent to said client device to facilitate populating said contact list.

93. The process of claim 51, wherein communication between said first processor-based device and said second processor-based device is by hypertext transfer protocol.

94. The process of claim 51, wherein communication between said first processor-based device and said second processor-based device is implemented via TCP/IP protocol.

95. The process of claim 51, wherein said customer information is input into client database upon receipt from said first processor based device.

96. The process of claim 51, wherein said retrieving further comprises retrieving service provider information, wherein said service provider information includes one or more of the following:
(i) one or more service provider categories;
(ii) one or more a service provider names;
(iii) one or more service provider addresses;
(iv) one or more service provider phone numbers;
(v) one or more service provider advertisements;
(vi) information specific to one or more service providers' business;
(vii) one or more link to service providers' websites; and
(viii) one or more link to one or more service providers' phone number.

97. The process of claim 96, wherein said sending further comprises sending said service provider information.

98. The process of claim 51, wherein said contact list includes service provider information, wherein said service provider information includes one or more of the following:
(i) one or more service provider categories;
(ii) one or more a service provider names;
(iii) one or more service provider addresses;
(iv) one or more service provider phone numbers;
(v) one or more service provider advertisements;
(vi) information specific to one or more service providers' business;
(vii) one or more link to service providers' websites; and
(viii) one or more link to one or more service providers' phone number.

99. The process of claim 51, wherein said client database is a relational database.

100. The process of claim 51, wherein said service provider database is a relational database.

101. A system for implementing a contact list using a client device coupled to a first processor-based device comprising:
a first database containing customer information;
a second database containing service provider information; and
a second processor based device having a memory, said memory storing data of said first database and said second database, wherein said second processor-based device is configured to conduct a search of said first database to identify location identifying information associated with said client device; search said second database to identify service provider phone numbers that correspond to said location identifying information associated with said client device; retrieve at least one of said service provider phone numbers that correspond to said location identifying information from said second database, and then send said at least one of said service provider phone numbers to said client device to facilitate populating said contact list.

102. The system of claim 101, wherein said second processor based device is configured to search for a unique client identifier.

103. The system of claim 102, wherein said unique client identifier comprises a customer identifier.

104. The system of claim 102, wherein said unique client identifier comprises a serial number associated with said client device.

105. The system of claim 102, wherein said unique client identifier further comprises a password.

106. The system of claim 101, wherein said unique client identifier is a customer phone number.

107. The system of claim 101, wherein said unique client identifier is an Internet Protocol address.

108. The system of claim 101, wherein said unique client identifier is a network interface code.

109. The system of claim 101, wherein said first processor-based device is coupled via at least one communications network to said second processor-based device.

110. The system of claim 101, wherein said first processor-based device is coupled via at least one data network to said second processor-based device.

111. The system of claim 110, wherein said data network is a packet-switched network.

112. The system of claim 101, wherein said client device comprises a USB device.

113. The system of claim 101, wherein said client device comprises a DECT phone.

114. The system of claim 101, wherein said client device comprises a cellular phone.

115. The system of claim 101, wherein said second processor-based device is configured to determine whether the unique client identifier is an authorized unique client identifier.

116. The system of claim 101, wherein said location identifying information comprises a zip code.

117. The system of claim 101, wherein said location identifying information comprises a state.

118. The system of claim 101, wherein said location identifying information comprises a municipality.

119. The system of claim 101, wherein said location identifying information comprises a street address.

120. The system of claim 101, wherein said location identifying information comprises latitude and longitude coordinates.

121. The system of claim 101, wherein said location identifying information comprises global positioning system coordinates.

122. The system of claim 101, wherein said location identifying information comprises information defining an area based on certain market characteristics.

123. The system of claim 101, further comprising a step of retrieving demographic information associated with said unique client identifier from said client database.

124. The system of claim 123, wherein said demographic information comprises the age of a person.

125. The system of claim 123, wherein said demographic information comprises the employment status of a person.

126. The system of claim 123, wherein said demographic information comprises the gender of a person.

127. The system of claim 123, wherein said demographic information comprises the income of a person.

128. The system of claim 123, wherein said demographic information comprises the marital status of a person.

129. The system of claim 123, further comprising retrieving at least one of said service provider phone numbers that correspond to both said location identifying information and said demographic information from said service provider database.

130. The system of claim 101, wherein said second processor-based device is configured to determine whether said service provider phone numbers correspond to said location identifying information based on whether said service provider phone numbers are associated with the same zip code as reflected in said location identifying information.

131. The system of claim 101, wherein said second processor-based device is configured to determine whether said service provider phone numbers correspond to said location identifying information based on whether said service provider phone numbers are associated with the same state as reflected in said location identifying information.

132. The system of claim 101, wherein said second processor-based device is configured to determine whether said service provider phone numbers correspond to said location identifying information based on whether said service provider phone numbers are associated with the same municipality as reflected in said location identifying information.

133. The system of claim 101, wherein said second processor-based device is configured to determine whether said service provider phone numbers correspond to said location identifying information based on whether said service provider phone numbers are associated with the same street address as reflected in said location identifying information.

134. The system of claim 101, wherein said second processor-based device is configured to determine whether said service provider phone numbers correspond to said location identifying information based on whether said service provider phone numbers are associated with the same latitude and longitude coordinates as reflected in said location identifying information.

135. The system of claim 101, wherein said second processor-based device is configured to determine whether said service provider phone numbers correspond to said location identifying information based on whether said service provider phone numbers are associated with the same global positioning system coordinates as reflected in said location identifying information.

136. The system of claim 101, wherein said second processor-based device is configured to determine whether said service provider phone numbers correspond to said location identifying information based on whether said service provider phone numbers are associated with the same information defining an area based on certain market characteristics as reflected in said location identifying information.

137. The system of claim 101, wherein said second processor-based device is configured to determine whether said service provider phone numbers correspond to said location identifying information based on whether said service provider phone numbers are associated with a first zip code included within a first group of zip codes that also includes a second zip code reflected in said location identifying information.

138. The system of claim 101, wherein said second processor-based device is configured to determine whether said service provider phone numbers correspond to said location identifying information based on whether said service provider phone numbers are associated with a geographic area that is also associated with said location identifying information, said geographic area being defined by a predetermined set of market characteristics.

139. The system of claim 101, wherein said second processor-based device is configured to determine if any of said service provider phone numbers that have been retrieved are duplicative of a set of service provider phone numbers previously sent to said client device to facilitate populating said contact list.

140. The system of claim 139, wherein said second processor-based device is configured to send only those service provider phone numbers that are not duplicative of a set of service provider phone numbers previously sent to said client device to facilitate populating said contact list.

141. The system of claim 101, wherein said second processor-based device is configured to determine if any of said service provider numbers are duplicative of a set of service provider phone numbers previously sent to said client device to facilitate populating said contact list.

142. The system of claim 141, wherein said second processor-based device is configured to retrieve only those service provider phone numbers which are not duplicative of a set of service provider phone numbers previously sent to said client device to facilitate populating said contact list.

143. The system of claim 101, wherein communication between said first processor-based device and said second processor-based device is by hypertext transfer protocol.

144. The system of claim 101, wherein communication between said first processor-based device and said second processor-based device is implemented via TCP/IP protocol.

145. The system of claim 101, wherein said customer information is input into client database upon receipt from said client device.

146. A system for implementing a contact list using a client device coupled to a first processor-based device comprising:
a first database containing customer information;
a second database containing service provider information; and
a second processor based device having a memory, said memory storing data of said first database and said second database, wherein said second processor-based device is configured to conduct a search of said first database to identify location identifying information associated with said client device; search said second database to identify service provider phone numbers that correspond to said location identifying information associated with said client device; retrieve at least one of said service provider phone numbers that correspond to said location identifying information from said second database, and then send said at least one of said service provider phone numbers to said first processor based device to facilitate populating said contact list.

147. The system of claim 146, wherein said unique client identifier is a customer phone number.

148. The system of claim 146, wherein said unique client identifier is an Internet Protocol address.

149. The system of claim 146, wherein said unique client identifier is a network interface code.

150. The system of claim 146, wherein said first processor-based device is coupled via at least one communications network to said second processor-based device.

151. The system of claim 146, wherein said first processor-based device is coupled via at least one data network to said second processor-based device.

152. The system of claim 151, wherein said data network is a packet-switched network.

153. The system of claim 146, wherein said client device comprises a USB device.

154. The system of claim 146, wherein said client device comprises a DECT phone.

155. The system of claim 146, wherein said client device comprises a cellular phone.

156. The system of claim 146, wherein said second processor-based device is configured to determine whether the unique client identifier is an authorized unique client identifier.

157. The system of claim 146, wherein said location identifying information comprises a zip code.

158. The system of claim 146, wherein said location identifying information comprises a state.

159. The system of claim 146, wherein said location identifying information comprises a municipality.

160. The system of claim 146, wherein said location identifying information comprises a street address.

161. The system of claim 146, wherein said location identifying information comprises latitude and longitude coordinates.

162. The system of claim 146, wherein said location identifying information comprises global positioning system coordinates.

163. The system of claim 146, wherein said location identifying information comprises information defining an area based on certain market characteristics.

164. The system of claim 146, further comprising a step of retrieving demographic information associated with said unique client identifier from said client database.

165. The system of claim 164, wherein said demographic information comprises the age of a person.

166. The system of claim 164, wherein said demographic information comprises the employment status of a person.

167. The system of claim 164, wherein said demographic information comprises the gender of a person.

168. The system of claim 164, wherein said demographic information comprises the income of a person.

169. The system of claim 164, wherein said demographic information comprises the marital status of a person.

170. The system of claim 164, further comprising retrieving at least one of said service provider phone numbers that correspond to both said location identifying information and said demographic information from said service provider database.

171. The system of claim 146, wherein said second processor-based device is configured to determine whether said service provider phone numbers correspond to said location identifying information based on whether said service provider phone numbers are associated with the same zip code as reflected in said location identifying information.

172. The system of claim 146, wherein said second processor-based device is configured to determine whether said service provider phone numbers correspond to said location identifying information based on whether said service provider phone numbers are associated with the same state as reflected in said location identifying information.

173. The system of claim 146, wherein said second processor-based device is configured to determine whether said service provider phone numbers correspond to said location identifying information based on whether said service provider phone numbers are associated with the same municipality as reflected in said location identifying information.

174. The system of claim 146, wherein said second processor-based device is configured to determine whether said service provider phone numbers correspond to said location identifying information based on whether said service provider phone numbers are associated with the same street address as reflected in said location identifying information.

175. The system of claim 146, wherein said second processor-based device is configured to determine whether said service provider phone numbers correspond to said location identifying information based on whether said service provider phone numbers are associated with the same latitude and longitude coordinates as reflected in said location identifying information.

176. The system of claim 146, wherein said second processor-based device is configured to determine whether said service provider phone numbers correspond to said location identifying information based on whether said service provider phone numbers are associated with the same global positioning system coordinates as reflected in said location identifying information.

177. The system of claim 146, wherein said second processor-based device is configured to determine whether said service provider phone numbers correspond to said location identifying information based on whether said service provider phone numbers are associated with the same information defining an area based on certain market characteristics as reflected in said location identifying information.

178. The system of claim 146, wherein said second processor-based device is configured to determine whether said service provider phone numbers correspond to said location identifying information based on whether said service provider phone numbers are associated with a first zip code included within a first group of zip codes that also includes a second zip code reflected in said location identifying information.

179. The system of claim 146, wherein said second processor-based device is configured to determine whether said service provider phone numbers correspond to said location identifying information based on whether said service provider phone numbers are associated with a geographic area that is also associated with said location identifying information, said geographic area being defined by a predetermined set of market characteristics.

180. The system of claim 146, wherein said second processor-based device is configured to determine if any of said service provider phone numbers that have been retrieved are duplicative of a set of service provider phone numbers previously sent to said client device to facilitate populating said contact list.

181. The system of claim 180, wherein said second processor-based device is configured to send only those service provider phone numbers that are not duplicative of a set of service provider phone numbers previously sent to said client device to facilitate populating said contact list.

182. The system of claim 146, wherein said second processor-based device is configured to determine if any of said service provider numbers are duplicative of a set of service provider phone numbers previously sent to said client device to facilitate populating said contact list.

183. The system of claim 180, wherein said second processor-based device is configured to retrieve only those service provider phone numbers which are not duplicative of a set of service provider phone numbers previously sent to said client device to facilitate populating said contact list.

184. The system of claim 146, wherein communication between said first processor-based device and said second processor-based device is by hypertext transfer protocol.

185. The system of claim 146, wherein communication between said first processor-based device and said second processor-based device is implemented via TCP/IP protocol.

186. The system claim 146, wherein said customer information is input into client database upon receipt from said first processor device.

187. A process for populating a contact list using a client device, said process comprising:
(i) transmitting a unique client identifier to a server, wherein said server is adapted to provide a customer location identifier corresponding to said unique client identifier; and
(ii) receiving entries for said contact list, wherein said entries include service provider phone numbers corresponding to said customer location identifier.

188. The process of claim 187, wherein said unique client identifier is a customer phone number.

189. The process of claim 187, wherein said unique client identifier is an Internet Protocol address.

190. The process of claim 187, wherein said unique client identifier is a network interface code.

191. The process of claim 187, wherein said client device is coupled via at least one communications network to said server.

192. The process of claim 187, wherein said client device is coupled via at least one data network to said server.

193. The process of claim 192, wherein said data network is a packet-switched network.

194. The process of claim 187, wherein said client device comprises a USB device.

195. The process of claim 187, wherein said client device comprises a DECT phone.

196. The process of claim 187, wherein said client device comprises a cellular phone.

197. The process of claim 187, wherein said location identifying information comprises a zip code.

198. The process of claim 187, wherein said location identifying information comprises a state.

199. The process of claim 187, wherein said location identifying information comprises a municipality.

200. The process of claim 187, wherein said location identifying information comprises a street address.

201. The process of claim 187, wherein said location identifying information comprises latitude and longitude coordinates.

202. The process of claim 187, wherein said location identifying information comprises global positioning system coordinates.

203. The process of claim 187, wherein said location identifying information comprises information defining an area based on certain market characteristics.

204. The process of claim 187, wherein demographic information is associated with said unique client identifier.

205. The process of claim 204, wherein said demographic information comprises the age of a person.

206. The process of claim 204, wherein said demographic information comprises the employment status of a person.

207. The process of claim 204, wherein said demographic information comprises the gender of a person.

208. The process of claim 204, wherein said demographic information comprises the income of a person.

209. The process of claim 204, wherein said demographic information comprises the marital status of a person.

210. The process of claim 187, wherein said service provider phone numbers correspond to said location identifying information if said service provider phone numbers are associated with the same zip code as reflected in said location identifying information.

211. The process of claim 187, wherein said service provider phone numbers correspond to said location identifying information if said service provider phone numbers are associated with the same state as reflected in said location identifying information.

212. The process of claim 187, wherein said service provider phone numbers correspond to said location identifying information if said service provider phone numbers are associated with the same municipality as reflected in said location identifying information.

213. The process of claim 187, wherein said service provider phone numbers correspond to said location identifying information if said service provider phone numbers are associated with the same street address as reflected in said location identifying information.

214. The process of claim 187, wherein said service provider phone numbers correspond to said location identifying information if said service provider phone numbers are associated with the same latitude and longitude coordinates as reflected in said location identifying information.

215. The process of claim 187, wherein said service provider phone numbers correspond to said location identifying information if said service provider phone numbers are associated with the same global positioning system coordinates as reflected in said location identifying information.

216. The process of claim 187, wherein said service provider phone numbers correspond to said location identifying information if said service provider phone numbers are associated with the same information defining an area based on certain market characteristics as reflected in said location identifying information.

217. The process of claim 187, wherein said service provider phone numbers correspond to said location identifying information if said service provider phone numbers are associated with a first zip code included within a first group of zip codes that also includes a second zip code reflected in said location identifying information.

218. The process of claim 187, wherein said service provider phone numbers correspond to said location identifying information if said service provider phone numbers are associated with a geographic area that is also associated with said location identifying information, said geographic area being defined by a predetermined set of market characteristics.

219. The process of claim 187, wherein the step of receiving comprises receiving only those service provider phone numbers that are not duplicative of a set of service provider phone numbers already received by said client device to facilitate populating said contact list.

220. The process of claim 187, wherein said step of receiving comprises receiving only those service provider phone numbers which are not duplicative of a set of service provider phone numbers previously sent to said client device to facilitate populating said contact list.

221. The process of claim 187, wherein communication between said client device and said server is by hypertext transfer protocol.

222. The process of claim 187, wherein communication between said client device and said server is implemented via TCP/IP protocol.

223. The process of claim 187, wherein said contact list includes service provider information, wherein said service provider information includes one or more of the following:
(i) one or more service provider categories;
(ii) one or more a service provider names;
(iii) one or more service provider addresses;
(iv) one or more service provider phone numbers;
(v) one or more service provider advertisements;
(vi) information specific to one or more service providers' business;
(vii) one or more link to service providers' websites; and
(viii) one or more link to one or more service providers' phone number.

224. A device capable of receiving service provider phone numbers to facilitate populating a contact list, the device comprising a processor component configured to transmit a unique client identifier to a server that determines a customer location identifier that corresponds to said unique client identifier and that identifies said service provider phone numbers based on said customer location identifier, said processor component receiving said service provider numbers from said server and populating said contact list with said service provider phone numbers.

225. The device of claim 224, wherein said unique client identifier is a customer phone number.

226. The device of claim 224, wherein said unique client identifier is an Internet Protocol address.

227. The device of claim 224, wherein said client identifier is a network interface code.

228. The device of claim 224, wherein said device is coupled via at least one communications network to said server.

229. The device of claim 224, wherein said device is coupled via at least one data network to said server.

230. The device of claim 229, wherein said data network is a packet-switched network.

231. The device of claim 224, wherein said device comprises a USB device.

232. The device of claim 224, wherein said device comprises a DECT device.

233. The device of claim 224, wherein said device comprises a cellular device.

234. The device of claim 224, wherein said location identifying information comprises a zip code.

235. The device of claim 224, wherein said location identifying information comprises a state.

236. The device of claim 224, wherein said location identifying information comprises a municipality.

237. The device of claim 224, wherein said location identifying information comprises a street address.

238. The device of claim 224, wherein said location identifying information comprises information defining an area based on certain market characteristics.

239. The device of claim 224, wherein demographic information is associated with said client identifier.

240. The device of claim 239, wherein demographic information comprises the age of a person.

241. The device of claim 239, wherein demographic information comprises the employment status of person.

242. The device of claim 239, wherein demographic information comprises the gender of a person.

243. The device of claim 239, wherein demographic information comprises the income of a person.

244. The device of claim 239, wherein demographic information comprises the marital status of a person.

245. The device of claim 224, wherein said service provider phone numbers correspond to said location identifier information if said provider phone numbers are associated with the same zip code as reflected in said location identifying information.

246. The device of claim 224, wherein said service provider phone numbers correspond to said location identifier information if said provider phone numbers are associated with the same state as reflected in said location identifying information.

247. The device of claim 224, wherein said service provider phone numbers correspond to said location identifier information if said provider phone numbers are associated with the same municipality as reflected in said location identifying information.

248. The device of claim 224, wherein said service provider phone numbers correspond to said location identifier information if said provider phone numbers are associated with the same street address as reflected in said location identifying information.

249. The device of claim 224, wherein said service provider phone numbers correspond to said location identifier information if said provider phone numbers are associated with the same latitude and longitude coordinates as reflected in said location identifying information.

250. The device of claim 224, wherein said service provider phone numbers correspond to said location identifier information if said provider phone numbers are associated with the same global positioning system coordinates as reflected in said location identifying information.

251. The device of claim 224, wherein said service provider phone numbers correspond to said location identifier information if said provider phone numbers are associated with the same information defining an area based on certain market characteristics as reflected in said location identifying information.

252. The device of claim 224, wherein said service provider phone numbers correspond to said location identifying information if said service provider phone numbers are associated with a first zip code included within a first group of zip codes that also includes a second zip code reflected in said location identifying information.

253. The device of claim 224, wherein said service provider phone numbers correspond to said location identifying information if said service provider phone numbers are associated with a geographic area that is also associated with said location identifying information, said geographic area being defined by a predetermined set of market characteristics.

254. The device of claim 224, wherein said processor component is configured to receive only those service provider phone numbers that are not duplicative of a set of service provider phone numbers already received by said processor component to facilitate populating said contact list.

255. The device of claim 224, wherein said processor component is configured to receive only those service provider phone numbers which are not duplicative of a set of service provider phone numbers previously received by the processor component to facilitate populating said contact list.

256. The device of claim 224, wherein communication between said device and said server is by hypertext transfer protocol.

257. The device of claim 224, wherein communication between said device and said server is implemented via TCP/IP protocol.

258. The device of claim 224, wherein said receiving service provider phone numbers further comprises receiving service provider information, wherein said service provider information includes one or more of the following:
(i) one or more service provider categories;
(ii) one or more a service provider names;
(iii) one or more service provider addresses;
(iv) one or more service provider phone numbers;
(v) one or more service provider advertisements;
(vi) information specific to one or more service providers' business;
(vii) one or more link to service providers' websites; and
(viii) one or more link to one or more service providers' phone number.

259. The device of claim 224, wherein said populating said contact list with said service provider phone numbers further comprises populating said contact list with service provider information, wherein said service provider information includes one or more of the following:
(i) one or more service provider categories;
(ii) one or more a service provider names;
(iii) one or more service provider addresses;
(iv) one or more service provider phone numbers;
(v) one or more service provider advertisements;
(vi) information specific to one or more service providers' business;
(vii) one or more link to service providers' websites; and
(viii) one or more link to one or more service providers' phone number.

260. The device of claim 224, wherein said contact list includes service provider information, wherein said service provider information includes one or more of the following:
(i) one or more service provider categories;
(ii) one or more a service provider names;
(iii) one or more service provider addresses;
(iv) one or more service provider phone numbers;
(v) one or more service provider advertisements;
(vi) information specific to one or more service providers' business;
(vii) one or more link to service providers' websites; and
(viii) one or more link to one or more service providers' phone number.

261. A computer-readable medium having computer-executable instructions stored thereon for performing a method of populating a contact list for a client device, said method comprising:
(i) transmitting a unique client identifier to a server, wherein said server is adapted to provide a customer location identifier corresponding to said unique client identifier; and
(ii) receiving entries for said contact list, wherein said entries include service provider phone numbers corresponding to said customer location identifier.

262. A computer-readable medium having computer-executable instructions stored thereon for performing a method of populating a contact list using a client device coupled to a first processor based device, said method comprising:
(i) receiving a unique client identifier from said client device;
(ii) conducting a first search of a client database to determine if said unique client identifier is present in said client database;
(iii) retrieving from said client database location identifying information associated with said unique client identifier, if a determination is made that said unique client identifier is present in said client database;
(iv) searching a service provider database to identify service provider phone numbers that correspond to said location identifying information associated with said unique client identifier;
(v) retrieving at least one of said service provider phone numbers that correspond to said location identifying information from said service provider database; and then
(vi) sending said at least one of said service provider phone numbers to said client device, such that said client device implements said contact list using said at least one of said service provider phone numbers.

263. A computer-readable medium having computer-executable instructions stored thereon for performing a method of populating a contact list for a client device coupled to a first processor based device, said method comprising:
(i) receiving a unique client identifier from said client device;
(ii) conducting a first search of a client database to determine if said unique client identifier is present in said client database;
(iii) retrieving from said client database location identifying information associated with said unique client identifier, if a determination is made that said unique client identifier is present in said client database;
(iv) searching a service provider database to identify service provider phone numbers that correspond to said location identifying information associated with said unique client identifier;
(v) retrieving at least one of said service provider phone numbers that correspond to said location identifying information from said service provider database; and then
(vi) sending said at least one of said service provider phone numbers to said client device, such that said first processor device implements said contact list using said at least one of said service provider phone numbers.

264. A process for populating a contact list using a computer having a first processor based device, said process comprising:
(i) receiving a unique client identifier from said computer;
(ii) conducting a first search of a client database to determine if said unique client identifier is present in said client database;
(iii) retrieving from said client database location identifying information associated with said unique client identifier, if a determination is made that said unique client identifier is present in said client database;
(iv) searching a service provider database to identify service provider phone numbers that correspond to said location identifying information associated with said unique client identifier;
(v) retrieving at least one of said service provider phone numbers that correspond to said location identifying information from said service provider database; and then
(vi) sending said at least one of said service provider phone numbers to said computer, such that said computer implements said contact list using said at least one of said service provider phone numbers.

265. A process for populating a contact list for a computer having a first processor based device, said process comprising:
(i) receiving a unique client identifier from said computer;
(ii) conducting a first search of a client database to determine if said unique client identifier is present in said client database;
(iii) retrieving from said client database location identifying information associated with said unique client identifier, if a determination is made that said unique client identifier is present in said client database;
(iv) searching a service provider database to identify service provider phone numbers that correspond to said location identifying information associated with said unique client identifier;
(v) retrieving at least one of said service provider phone numbers that correspond to said location identifying information from said service provider database; and then
(vi) sending said at least one of said service provider phone numbers to said first processor based device, such that said first processor based device implements said contact list using said at least one of said service provider phone numbers.

266. A system for implementing a contact list using a computer having a first processor based device comprising:
(i) a first database containing customer information;
(ii) a second database containing service provider information; and
(iii) a second processor based device having a memory, said memory storing data of said first database and said second database, wherein said second processor-based device is configured to conduct a search of said first database to identify location identifying information associated with said computer device; search said second database to identify service provider phone numbers that correspond to said location identifying information associated with said computer; retrieve at least one of said service provider phone numbers that correspond to said location identifying information from said second database, and then send said at least one of said service provider phone numbers to said computer to facilitate populating said contact list.

267. A system for implementing a contact list using a computer having a first processor based device comprising:
(i) a first database containing customer information;
(ii) a second database containing service provider information; and
(iii) a second processor based device having a memory, said memory storing data of said first database and said second database, wherein said second processor-based device is configured to conduct a search of said first database to identify location identifying information associated with said computer; search said second database to identify service provider phone numbers that correspond to said location identifying information associated with said computer; retrieve at least one of said service provider phone numbers that correspond to said location identifying information from said second database, and then send said at least one of said service provider phone numbers to said first processor based device to facilitate populating said contact list.

268. A process for populating a contact list using a computer, said process comprising:
(i) transmitting a unique client identifier to a server, wherein said server is adapted to provide a customer location identifier corresponding to said unique client identifier; and
(ii) receiving entries for said contact list, wherein said entries include service provider phone numbers corresponding to said customer location identifier.

269. A computer capable of receiving service provider phone numbers to facilitate populating a contact list, the computer comprising a processor component configured to transmit a unique client identifier to a server that determines a customer location identifier that corresponds to said unique client identifier and that identifies said service provider phone numbers based on said customer location identifier, said processor component receiving said service provider numbers from said server and populating said contact list with said service provider phone numbers.

270. A computer-readable medium having computer-executable instructions stored thereon for performing a method of populating a contact list for a computer, said method comprising:
(i) transmitting a unique client identifier to a server, wherein said server is adapted to provide a customer location identifier corresponding to said unique client identifier; and
(ii) receiving entries for said contact list, wherein said entries include service provider phone numbers corresponding to said customer location identifier.

271. A computer-readable medium having computer-executable instructions stored thereon for performing a method of populating a contact list using a computer having a first processor based device, said method comprising:
(i) receiving a unique client identifier from said computer;
(ii) conducting a first search of a client database to determine if said unique client identifier is present in said client database;
(iii) retrieving from said client database location identifying information associated with said unique client identifier, if a determination is made that said unique client identifier is present in said client database;
(iv) searching a service provider database to identify service provider phone numbers that correspond to said location identifying information associated with said unique client identifier;
(v) retrieving at least one of said service provider phone numbers that correspond to said location identifying information from said service provider database; and then
(vi) sending said at least one of said service provider phone numbers to said computer, such that said computer implements said contact list using said at least one of said service provider phone numbers.

272. A computer-readable medium having computer-executable instructions stored thereon for performing a method of populating a contact list for a computer having a first processor based device, said method comprising:
(i) receiving a unique client identifier from said computer;
(ii) conducting a first search of a client database to determine if said unique client identifier is present in said client database;
(iii) retrieving from said client database location identifying information associated with said unique client identifier, if a determination is made that said unique client identifier is present in said client database;
(iv) searching a service provider database to identify service provider phone numbers that correspond to said location identifying information associated with said unique client identifier;
(v) retrieving at least one of said service provider phone numbers that correspond to said location identifying information from said service provider database; and then
(vi) sending said at least one of said service provider phone numbers to said computer, such that said first processor device implements said contact list using said at least one of said service provider phone numbers.
